(19) United States
(12) Patent Application Publication
(10) Pub. No.: US 2023/0315497 A1
(43) Pub. Date: Oct. 5, 2023

(54) WAITING PERIOD DETERMINATION USING AN AGENT

(71) Applicant: Hewlett Packard Enterprise Development LP, Houston, TX (US)

(72) Inventors: Ju-Chun Lou, Taipei City (TW); Chao Hsu Chen, Taipei City (TW)

(21) Appl. No.: 17/657,957

(22) Filed: Apr. 5, 2022

(51) Int. Cl. G06F 9/451

(52) U.S. Cl. CPC G06F 9/452

(57) ABSTRACT

Examples described herein relate to determining the waiting period using an agent. Examples include a source device transmitting a request to a target device to perform an action and waiting for a response to the request for an expected waiting period. Examples include an agent to detect an event at the target device and notify the source device to abort the request. The agent may determine an adjusted waiting period for completion of the action due to the event. For a new request, the source device may wait for a period corresponding to the adjusted waiting period.

### BACKGROUND

Often, a central entity manages customer site devices, such as computing devices (e.g., servers, computers), and network infrastructure devices (e.g., controllers, switches) via a remote connection. For example, the central entity may remotely perform software or firmware upgrades, troubleshooting procedures, automated software testing, or the like, on the customer site devices. Such operations involve communication of requests from the central entity to perform certain actions (e.g., power on, virus scan) at a target device at the remote customer site. The target device may send responses to such requests (e.g., acknowledgment signal, status, etc.) to the central entity.

In some implementations, after the central entity sends a request for an action to be fulfilled by the target device, the central entity enters a “waiting state” to wait for a response from the target device. The central entity remains in the waiting state for a limited time to avoid wasting resources. For example, the central entity may execute a wait state mechanism (e.g., a timer) that allows the central entity to enter the waiting state to wait for a response from the target device for a certain period that is usually set to a predefined or fixed waiting time value. A request timeout occurs when a response is not received from the target device within that period after communicating the request to the target device. When the request timeout occurs, the central entity exits the waiting state and enters a timeout state. In the timeout state, the central entity aborts the request and stops waiting for the response.

### BRIEF DESCRIPTION OF THE DRAWINGS

For a more complete understanding of the present disclosure, examples in accordance with the various features described herein may be more readily understood with reference to the following detailed description taken in conjunction with the accompanying drawings, where like reference numerals designate like structural elements, and in which:

FIG. 1 is a block diagram depicting an example source device that determines a waiting period using an agent;

FIG. 2 is a flowchart of an example method to determine a waiting period using an agent;

FIG. 3 is a flowchart of another example method to determine a waiting period using an agent;

FIG. 4 is an example experience table; and

FIG. 5 is a block diagram depicting a processing resource and a machine-readable medium encoded with example instructions to determine a waiting period using an agent;

Certain examples have features that are in addition to or in lieu of the features illustrated in the above-referenced figures. Certain labels may be omitted from certain figures for the sake of clarity.

### DETAILED DESCRIPTION

As noted above, a central entity (referred to herein as source device) uses a wait state mechanism to switch from a waiting state to a timeout state and aborts a request for an action when a response is not received from a target entity (referred to herein as target device) within a fixed waiting period. Although such a mechanism allows the source device to avoid wasting resources (e.g., network, processing resources), the source device has to resend the request to the target device for completing the action. Before resending the request, the source device adjusts (e.g., increases) the waiting period in an attempt to receive a response indicating completion of the action from the target device. In some cases, the source device has to adjust the waiting period and resend the request several times until a response is received from the target device. This causes a delay in processing requests sent from the source device.

For example, if the source device receives a response to the request from the target device after the expiry of the waiting period, simply increasing the waiting period and resending the request can avoid an unwanted timeout situation. However, there are certain challenges to this solution. The adjusted waiting period is still a static or fixed wait time value. This means that the resulting waiting period would not be appropriate for all types of scenarios. For example, for a high-performance server (e.g., target device) on a high-speed network, the processing time and response time of the server are expected to be shorter. If the waiting period is adjusted down (e.g., decreased) to accommodate this particular scenario, the decreased waiting period may create many unwanted timeout situations for other servers with lower performance levels and/or operating on a network with a lower speed. Moreover, if the target device is too busy to process and/or respond to the request from the source device, an increased waiting period may cause the source device to wait for an unreasonably long time, resulting in inefficient utilization of resources at the source device.

In some existing systems, the source device maintains a database storing historical waiting periods for each completed action. The source device can predict and dynamically adjust the waiting periods for an action based on the historical waiting periods associated with that action. However, these solutions may not be useful when sufficient historical waiting period data is not available. For example, if the database does not include historical values for a new type of action (e.g., monitoring resources), then the source device would not be able to determine an appropriate waiting period. Further, these solutions may be limited as they may not consider communication delays due to unexpected events (e.g., hardware failure, software issues, etc.) at the target device.

In some example scenarios, the target device may have undergone a reconfiguration of hardware, firmware, or software components. Reconfiguration of the target device (e.g., servers) may be performed as part of maintenance or upgrading the components of the target device, for example. Examples of reconfiguration include changes or replacement of hardware components (e.g., random access memory (RAM)), updating firmware or software components (e.g., system images, operating systems), or the like. Such reconfiguration at the target device may usually modify a boot time (i.e., time taken by the target device to be ready to operate after power has been turned on or after initiating a restart) to initialize drivers associated with a new hardware component or to authenticate updated firmware or software components, etc. For example, if a memory component, such as a memory module with 2DPC (two Dual inline memory module Per Channel) is changed to 1DPC, then the boot time may decrease due to quicker initialization of the 1DPC memory module. On the other hand, if 1DPC memory module is changed to 2DPC memory module, then the boot time may increase due to a slower initialization of 2DPC. In other scenarios, the target device may experience failure of the hardware, software, or firmware components. Failures may occur due to malfunction of hardware components, failed authentication of firmware or software components, system crashes, or the like. Such failures could lead to an increase in the boot time at the target device, and in some cases, failed boot-up of the target device.

In such scenarios, the target device would take additional time to respond to requests from a source device due to the increased boot time resulting from reconfiguration or component failure. In some instances, the target device may not respond to the requests as the booting process may halt due component failure. In such cases, the source device remains unaware of such events at the target device and keeps waiting for a response until the designated waiting period elapses. As a result, request processing gets delayed, and the source device may resend requests and waste resources.

In examples consistent with this disclosure, a source device stops waiting for a response from a target device when a reconfiguration or a failure event is detected at the target device. Examples disclose an agent executing on the source device to remotely detect such events at the target device that delay communication between the source and target devices. The agent can determine a delay in the completion of a requested action due to the event at the target device. The source device adjusts a waiting period according to the delay such that for subsequent requests for the action, the source device waits for an appropriate period. Based on such feedback from the agent, the waiting period may be selected such that it is sufficiently large to avoid unwanted timeout situations before receiving a response and sufficiently small to avoid wasting resources. In this manner, the source device avoids waiting for a longer period (i.e., until the designated period elapses) and utilizes resources more efficiently.

Examples of this disclosure improve the technical field of remote management of information technology devices, specifically in the subfield of event handling, troubleshooting, software test automation, etc. The technical improvements are achieved in administrative devices, test automation devices (e.g., test servers), etc. Examples of this disclosure improve such devices by, among other things, detecting events at a target device and exiting a waiting state to avoid wasting resources (e.g., processing, memory, bandwidth, etc.). Examples also allow the determination of appropriate waiting time values without historical wait time values associated with the action.

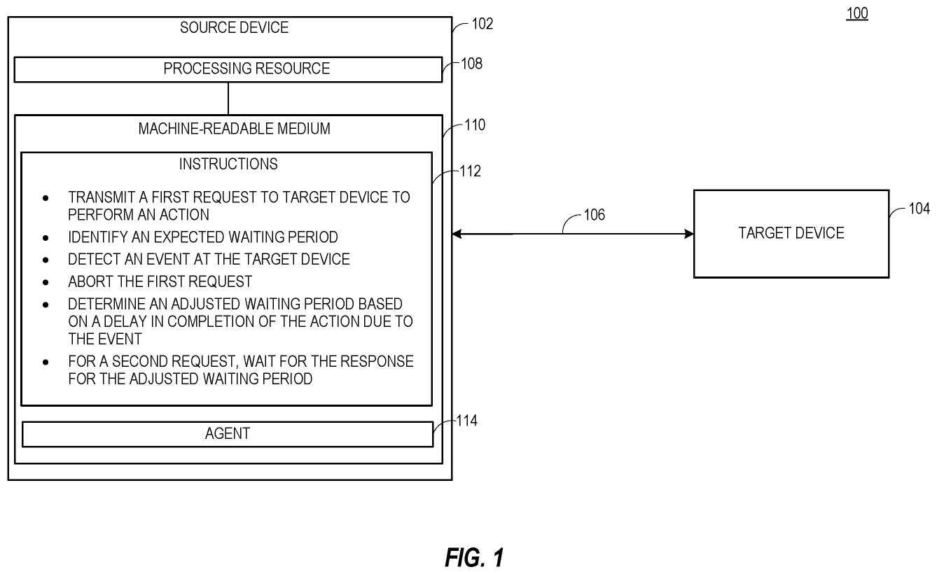

FIG. 1 illustrates an example network 100 including a source device 102 and a target device 104. The source device 102 and the target device 104 are communicatively coupled to each other as depicted via a network link 106. The network link 106 allows the source device 102 to manage the target device 104 in a remote manner. For example, the source device 102 may initiate diagnoses procedures (e.g., malware scan, event handling, etc.), component updates (e.g., software, firmware), software testing, or the like, to be performed on the target device 104. The term “source device” and “target device,” as used herein, may refer to a computing device or a process within a computing device. The source device 102 includes at least one processing resource 108 and at least one machine-readable medium 110 storing (e.g., encoded with) instructions 112. The machine-readable medium 110 also stores an agent 114. The processing resource 108 executes the instructions 112 and the agent 114 to determine appropriate waiting periods.

The processing resource 108 generates a request for an action to be responded or acted-upon by the target device 104. The term “action,” as used herein, may refer to any series of tasks or jobs relating to command distribution (e.g., installing a new operating system (OS)), a process execution (e.g., invoking a new service), communication protocol (e.g., initiation of remote management session), and/or any other task or job to be processed, executed, or otherwise performed by the target device 104.

The processing resource 108 transmits the request for action to the target device 104 via the network link 106. In some examples, the processing resource 108 changes a state of the source device 102. A ‘state’ is a source device operation mode. In examples described herein, the source device 102 can be in a waiting state or a timeout state. The source device may utilize more resources (e.g., power, computing, memory, or networking resources) in the waiting state. The source device 102 enters a waiting state after transmitting the request to the target device 104. In the waiting state, the source device 102 actively waits for a response to a transmitted request using one or more resources. For example, the source device 102 may load a set of instructions in a cache memory that are ready for execution to process a received response, monitor a source device interface (e.g., network interface cards) configured to receive a response, consume higher bandwidth over the network link 106, or the like. Generally, the target device 104 generates or otherwise provides a response to the request received from the source device 102 after addressing or completing the action. The response may include an indication (e.g., acknowledgment) that the action has been successfully processed, or that the action has failed, and/or any other indications of the status of the action. The target device 104 communicates the response to the source device 102 via the network link 106.

The processing resource 108 identifies an expected waiting period within which the response from the target device 104 is expected to be received. The term “expected waiting period” refers to an amount of time that the source device 102 is allowed to wait for a response for a request until a timeout state. Timeout state occurs when a response has not been received from the target device 104 within the amount of time corresponding to the waiting period after transmitting the request. When a timeout occurs, the source device aborts the request and stops waiting for a response to the request. In the timeout state, the source device 102 does not actively use the one or more resources. For example, the source device 102 may erase the set of instructions to free the cache memory, stop monitoring interfaces (i.e., NICs) configured to receive a response, consume less bandwidth over the network link 106, or the like.

In some examples, the processing resource 108 executes an agent 114, which is capable of interacting with another device, such as the target device 104. The agent 114 can establish a remote connection with the target device 104 and monitor or inspect configuration information of the target device 104. Configuration information includes characteristics associated with hardware, software, or firmware components of the target device 104. Such characteristics may be stored in a memory (e.g., read-only memory (ROM)) or may be gathered from various components of the target device 104. For example, a baseboard management controller in a server (target device) may gather and track information of the hardware components of the server. Certain characteristics may be static information about the target device (e.g., device name, model number, etc.). Other characteristics may be configuration information that occasionally or frequently change in the target device (e.g., operating system version, configured link speed, etc.).

The processing resource 108 executes the agent 114 to detect an event at the target device 104. The term “event,” as used herein, refers to a change in configuration or a failure of one or more of the hardware, software, or firmware components, at the target device 104. The agent 114 can access the system configuration settings of the target device 104 via the remote connection and identify reconfiguration or failure information at the target device. In some examples, the agent 114 interacts with a user interface of the target device 104 via the remote connection. For example, the agent 114 may select system configuration settings on the user interface and detect a change in a hardware component (e.g., NIC) at the target device 104.

The agent 114 notifies the source device 102 about the detection of the event. In response to such a notification, the processing resource 108 aborts the request and exits the waiting state to enter the timeout state. As a result, the source device 102 stops waiting for a response from the target device 104 even before the expected waiting period expires. After such expedited exit from the waiting state, the source device 102 may stop using resources, such as network resources that are configured to scan for responses to the requests, for example. In this manner, the source device 102 may prevent wasting some of the resources.

In some examples, the target device 104 continues executing the requested action, and the agent 114 remains connected to the target device 104 at least for a certain period after aborting the request. The agent 114 monitors the status of the action (i.e., whether the action is in progress or is completed) and determines a delay to complete the action due to the event. The processing resource 108 executes the instructions 112 to determine an adjusted waiting period that would correspond to the time taken to receive a response indicating completion of the action by the target device. In some examples, the processing resource 108 stores the adjusted waiting period in a database (e.g., a learning or experience table). When a new request for the action is generated and transmitted, the processing resource 108 can enter the waiting state and retrieve the adjusted waiting period from the database. The source device 102 may wait for a response for a period corresponding to the adjusted waiting period.

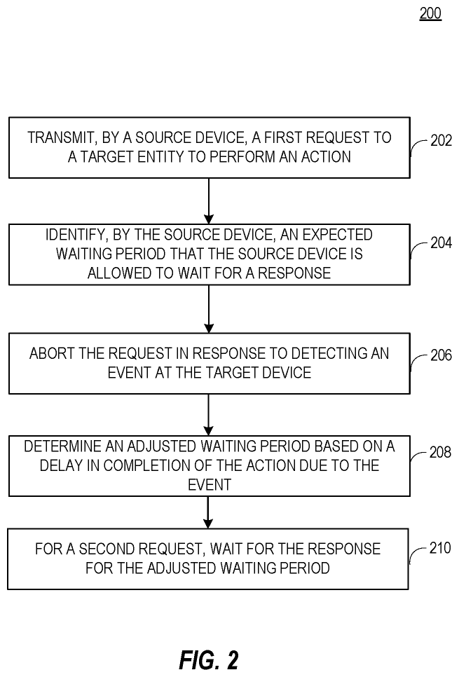

FIG. 2 is a flowchart illustrating an example method for determining the waiting period using an agent. In some examples, method 200 may be encoded as instructions in a computer-readable medium and executed on a computing device, such as the source device 102 of FIG. 1.

At block 202, method 200 includes transmitting a first request for an action from a source device to a target device. The first request includes at least a device identifier (identifying a target device) and metadata describing details regarding the requested action. For example, the metadata may include parameters, such as an action type. The action type may have a value of “update” (e.g., software or firmware update), “scan” (e.g., virus scan, malware scan, or the like), or the like. When the action type is “update,” the first request may also include additional metadata, such as software/firmware version, incremental/full update, etc. The source device may send multiple such requests (e.g., first, second, or third requests) to one or more target devices using various protocols (e.g., simple network management protocol (SNMP), hypertext transfer protocol (HTTP), or the like).

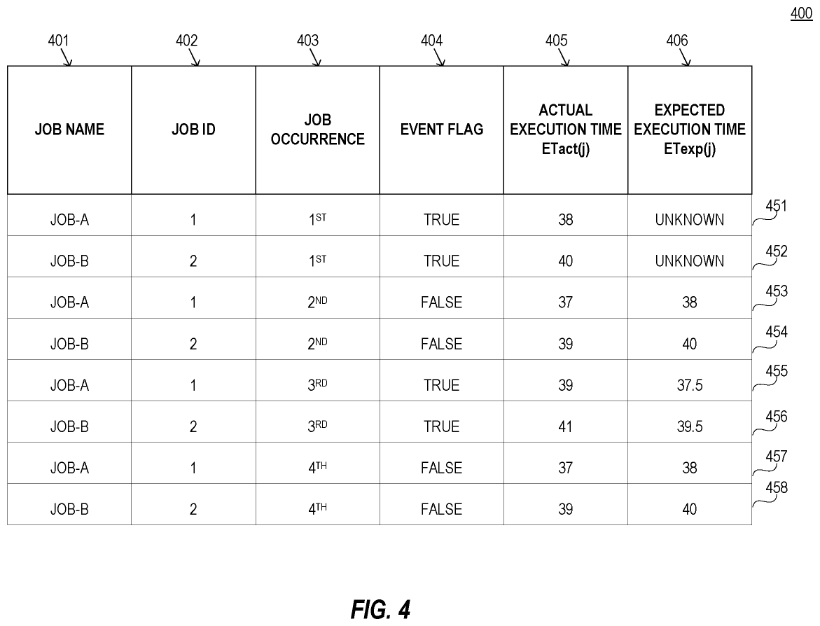

At block 204, method 200 includes identifying, by the source device, an expected waiting period (denoted by WPₑₓₚ(A)) corresponding to the action. To identify, the source device 102 performs a lookup operation in an experience table. The experience table (illustrated in more detail in FIG. 4) may be a database that stores historical values for at least expected and actual time taken for a response to each request from the source device 102. The expected waiting period WPₑₓₚ(A) may be an expected time to receive a response to the transmitted first request for action. The source device 102 retrieves the expected waiting period WPₑₓₚ(A) corresponding to the action from the experience table. After identifying the expected waiting period WPₑₓₚ(A), the source device 102 enters and remains in a waiting state to wait for a response from the target device 104 for the expected waiting period WPₑₓₚ(A).

At block 206, method 200 includes aborting the first request in response to detecting, by the agent 114, an event at the target device 104. The agent 114 establishes a remote connection from the source device to the target device 104. In some examples, client software of the agent 114 may be installed in the target device that allows establishing the remote connection with the agent 114 from the source device 102. For example, the client software of the agent 114 may be encoded in a baseboard management controller to track the various configuration information of the server (target device) and provide such information to the source device 102. The agent 114 also performs a series of automated steps to detect and diagnose the event at the target device 104. For example, the agent 114 may initiate a reboot process at the target device 104, and during the reboot process, identify the event at the target device 104. Examples of an event may include reconfigurations, i.e., changes in hardware components (e.g., NIC, RAM, read-only memory (ROM), etc.), software or firmware components (e.g., operating systems, bootloaders, etc.).

In some examples, the agent 114 interacts with a user interface of the target device 104 to identify the event. For example, the agent 114 can use an image recognition process to detect the user interface displayed on a display of the target device during the reboot process. The agent 114 can recognize and select the various options available in the user interface via the image recognition process. In some examples, the agent 114 detects that the user interface is displaying an option for system utilities and selects that option (e.g., by controlling cursor movement and clicking the option). In the system utilities, the agent 114 can check for any new reconfigurations (i.e., changes or replacement) of one or more of the hardware, software, and firmware components in the target device 104. The agent 114 provides updates to the source device regarding the detection of any reconfiguration at the target device 104.

The source device 102 aborts the first request in response to detection of the event at the target device. When the first request is aborted, the source device 102 exits the waiting state and enters a timeout state. As described earlier, the source device 102 consumes a smaller amount of resources after exiting the waiting state. In some examples, the target device 104 continues executing the action even after the first request is aborted.

At block 208, method 200 includes determining a delay to complete the action at the target device due to the event. The agent 114 monitors the status of the action (i.e., whether the action is in progress or is completed) and determines the actual time taken to complete the action despite the reconfiguration event. For example, if the reconfiguration at the target device included changes in hardware components like ROM, RAM, or NIC, then the target device may take a longer time to boot to initialize drivers for those components. In another example, if the reconfiguration at the target device included upgrading of the firmware, the target device may take a longer time to authenticate the upgraded firmware. For example, the target device may perform a cold boot, which may add to the time taken to authenticate firmware. This additional time adds to the time taken to complete the requested action by the target device 104.

The method 200 includes determining adjusted waiting period (denoted by WP_{adj}(A)) based on the delay to complete the action. For example, the source device 102 is notified about the time taken to complete the action due to the reconfiguration. The source device 102 determines the adjusted waiting period WP_{adj}(A) based on the time taken to complete the action and receive the response indicating the completion. In some examples, the source device 102 stores the adjusted waiting period WP_{adj}(A) in a database (e.g., experience table).

At block 210, when a new request (i.e., second request) for the action is generated and transmitted by the source device to the target device 104, method 200 includes waiting, by the source device, for a response from the target device for at least the adjusted waiting period WP_{adj}(A) for a previous occurrence of the same action. Subsequently, the source device 102 may enter and remain in the waiting state to wait for that period to receive a response.

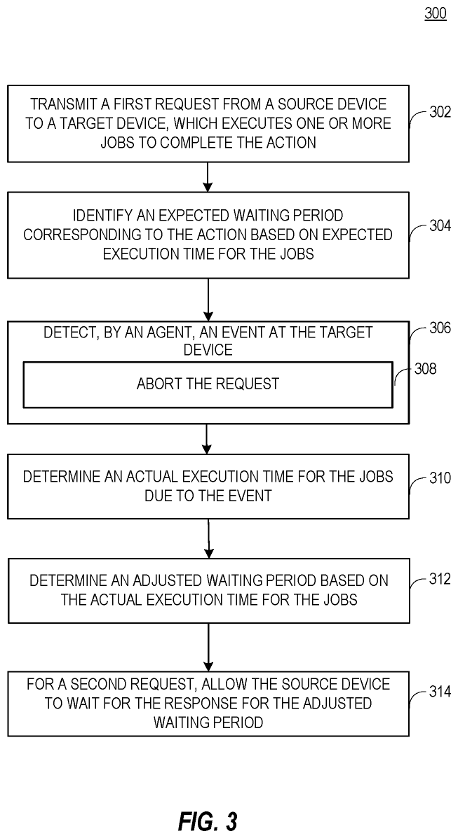

FIG. 3 is a flowchart illustrating another example method for determining the adjusted waiting period using an agent.

At block 302, method 300 includes transmitting a first request for an action from a source device to a target device, which performs one or more jobs to complete the action. For example, for an action such as powering-on a target device (e.g., a special purpose computer), jobs such as checking firmware, loading software (e.g., an operating system, drivers), or the like, may be executed. Likewise, for an action such as monitoring a resource, jobs such as checking firmware and creating a virtual machine may be executed. In other words, an action may be divided into atomic steps, which are referred to as jobs. In some examples, an action may be regarded as a job for certain other actions. For instance, an action, such as monitoring a resource may be regarded as a job for a high-level action such as generating a health alert for the resource.

At block 304, method 300 includes identifying an expected waiting period WPₑₓₚ(A) corresponding to the action based on the execution time for each of the one or more jobs. The expected waiting period WPₑₓₚ(A) may correspond to a period that the source device 102 is allowed to wait for a response to the first request until a timeout state. The source device 102 performs a lookup operation in the experience table. The experience table may be a database that stores expected and actual waiting time corresponding to previous executions of each job associated with an action. The source device 102 determines the expected waiting period WPₑₓₚ(A) corresponding to the action from the experience table.

In some examples, the expected waiting period WPₑₓₚ(A) is an aggregate (i.e., a sum) of the expected execution time ETₑₓₚ(j) for each job associated with the action. For example, the expected waiting period WPₑₓₚ(A) for an action, such as powering on, is the sum of expected execution time ETₑₓₚ(j) of the jobs, such as checking firmware and loading software. In some examples, the expected execution time ETₑₓₚ(j) for a job may be an average or a moving average of the actual execution time ET_{act}(j) of all previous occurrences of that job.

In other examples, the expected execution time may be a predetermined value (e.g., 60 seconds) if the actual execution time ET_{act}(j) for previous executions of the one or more jobs are not available. After identifying the expected waiting period WPₑₓₚ(A), the source device 102 enters into a waiting state to wait for a response from the target device 104. The source device 102 remains in the waiting state for a period corresponding to the expected waiting period WPₑₓₚ(A).

At block 306, method 300 includes detecting, by an agent, an event at the target device. After establishing a remote connection to the target device 104, the agent performs a series of automated steps to detect and diagnose the event at the target device 104. For example, the agent may initiate a reboot process at the target device 104. During the reboot process, the agent identifies the event at the target device 104. The event may be a reconfiguration or a failure of one or more components of the target device. In some examples, to identify the event, the agent interacts with a user interface of the target device. For example, the agent can perform an image recognition process to detect the user interface displayed on a display of the target device and perform interactive operations on the user interface. In some examples, the agent may invoke a machine learning (ML) method (or be trained using an ML algorithm) to detect patterns (e.g., via pattern recognition techniques), to parse and analyze textual information (e.g., via natural language processing (NLP) techniques), or the like.

In one example, the agent can recognize and select the various options available in the user interface using pattern recognition techniques and analyze the textual information using NLP. For example, the agent can select a graphical user interface object (e.g., icon) representing system utilities or other configuration settings using a color or design of the GUI object. The agent can check for any new reconfigurations (i.e., changes or replacement) of one or more of the hardware, software, and firmware components in the system utilities by parsing and analyzing the text in the user interface.

In another example, the agent can detect whether the user interface displays a failure screen via the image recognition process. The failure screen indicates that a failure event has occurred at the target device 104. In some examples, the agent may recognize the color of the failure screen and identify the type of failure at the target device. Examples of the failure screen include Purple Screen of Death (PSoD), Blue Screen of Death (BSoD), black screen, or the like. For example, BSoD and PSoD represent types of failure screens displayed on a computer system after a fatal system error or crash in an operating system. Such failure screens indicate that the target device can no longer operate safely. The agent identifies the failure screen and collects information, such as a core dump, to troubleshoot the event. BSoD and PSoD are just examples of failure screens; other types of failure screens are also detectable by the agent. Further, the agent provides updates to the source device regarding detection of any failure at the target device 104.

At block 308, method 300 includes aborting the first request in response to the detection of the failure. When the first request is aborted, the source device 102 exits the waiting state and enters a timeout state. In some examples, the agent launches a troubleshooting process (e.g., an exception handler) to remediate the failure at the target device. For example, the agent may initiate another reboot, provide diagnostic information (core dump) displayed on the failure screen to another device, such as the source device or an administrative device for analyses, such as root cause analysis. The agent may also restore a previous state of software or data (e.g., via snapshots) on the target device as part of the troubleshooting process. After completion of the troubleshooting process, the target device 104 continues executing the one or more jobs associated with the action requested by the source device 102.

At block 310, method 300 includes determining an actual execution time ET_{act}(j) for the one or more jobs due to the event. The agent monitors the status of each job (i.e., whether the job is in progress or is completed) and determines the actual time taken to execute the job. For example, the actual execution time for checking firmware may be 28 seconds and for loading software may be 40 seconds.

At block 312, method 300 includes determining an adjusted waiting period WP_{adj}(A) for an action based on the actual execution time ET_{act}(j) for the one or more jobs associated with the action. The adjusted waiting period WP_{adj}(A) may be the sum of the actual execution time for each job associated with the action. For example, the adjusted waiting period WP_{adj}(A) for an action, such as powering on, may be the sum of actual execution time for checking firmware (e.g., 28 seconds) and loading software (e.g., 40 seconds). The actual waiting period for receiving a response may be represented as

WP_{adj}(A)=Σᵢ₌₁ⁿET_{act}(j)ᵢ where “n” denotes the number of jobs associated with the action and “i” identifies a specific job.

At block 314, method 300 includes waiting, by the source device, for the response from the target device for at least a period corresponding to the adjusted waiting period WP_{adj}(A) in response to transmitting a second request for the action to the target device. Subsequently, the source device 102 may enter the waiting state to wait for the adjusted waiting period WP_{adj}(A).

FIG. 4 illustrates an example experience table 400. The experience table 400 may represent a database storing historical execution time values for one or more jobs associated with each action requested by the source device. Such a database may be a remote database connected over a network, such as network link 106 of FIG. 1. Alternatively, the database may be a local database in the source device 102, for example.

In the example of FIG. 4, the experience table 400 stores information of two jobs (labeled as “JOB-A” and “JOB-B”) associated with an action. For example, the action may be powering-on the target device and the jobs may be checking firmware (JOB-A) and loading software (JOB-B). The experience table 400 stores various information, such as job name 401, job identifier 402, job occurrence 403, event flag 404, actual execution time 405, and expected execution time 406 associated with each job. The job name 401 indicates a name of the job (e.g., JOB-A, JOB-B, and so on) and the job identifier 402 identifies the job using an identifier (e.g., numerical values like 1, 2, etc.). The job occurrence 403 indicates the instance of the corresponding job. For example, when a job is performed for the first time, its occurrence would be “1^{st}”. When the same job is performed for the second time, its occurrence would be “2^{nd}” and so on. The event flag 404 indicates whether the agent 114 detected an event at the target device before or while performing the job. If the event flag 404 is “TRUE”, it indicates that an event had occurred at the target device 104. If the event flag 404 is “FALSE”, it indicates that no event has occurred at the target device 104. The actual execution time ET_{act}(j) 405 indicates the amount of time taken to complete a job and the expected execution time 406 indicates the amount of time expected to complete a job.

The experience table 400 also includes entries 451, 452, 453, 454, 455, 456, 457, 458, each specifying information associated with a respective job. The entries 451, 452 include information associated with the first occurrence of checking firmware (JOB-A) and loading software (JOB-B), respectively. The expected execution time ETₑₓₚ(j) 406 for the first occurrence is “UNKNOWN” as historical execution time values are unavailable. In such instances, the source device 102 waits for a response time corresponding to a predetermined waiting time value. For example, the predetermined waiting time value may be 60 seconds. In some examples, before execution of the jobs, the agent determines whether an event has occurred at the target device 104. If the agent detects an event, such as a hardware reconfiguration, then the agent notifies the source device 102 to abort the request and to stop waiting for a response. Accordingly, the source device 102 updates the event flag 404 as “TRUE” for JOB-A and JOB-B. The agent monitors the progress of the job (checking firmware) at the target device. For example, the agent determines the actual time taken to check firmware and load software (e.g., operating system, drivers, etc.). The agent records that time as the actual execution time ET_{act}(j) 405 in the experience table 400. For example, the actual execution time 405 for JOB-A is 38 seconds and for loading software is 40 seconds.

In some examples, the source device 102 transmits a second request for the same action (i.e., powering on) to the same target device 104 (or alternatively a different target device). The jobs (checking firmware and loading software) performed associated with powering on are considered as second occurrences. The entries 453, 454 include information associated with the second occurrence of the JOB-A and the JOB-B. The expected execution time ETₑₓₚ(j) 406 for the jobs JOB-A and JOB-B are considered as the average of the actual execution time ET_{act}(j) for previous occurrences of the jobs. For example, the average execution time for previous execution of JOB-A is 38 seconds and for JOB-B is 40 seconds. The source device enters the waiting state and starts waiting for a period corresponding to the expected waiting period WPₑₓₚ(A). The expected waiting period WPₑₓₚ(A) is a sum of the expected execution time of the JOB-A and JOB-B, i.e., WPₑₓₚ(A)=40+38=78 seconds. During this occurrence, the agent does not detect any event at the target device 104. The source device updates the event flag 404 as “FALSE” in the experience table 400. Further, the source device receives the response from the target device and records the actual time taken as the actual execution time ET_{act}(j). For example, the actual execution time ET_{act}(j) 405 for JOB-A may be 37 seconds and for JOB-B may be 39 seconds.

Later, the source device 102 transmits a third request for the same action (i.e., powering on) to the target device 104. The jobs (checking firmware and loading software) performed associated with powering on are considered as third occurrences. The entries 455, 456 include information associated with the third occurrence of JOB-A and JOB-B as indicated in 403. The expected execution time ETₑₓₚ(j) 406 for the jobs JOB-A and JOB-B are considered as the average of the actual execution time ET_{act}(j) for previous occurrences of the jobs. For example, the average actual execution time ET_{act}(j) for previous execution of JOB-A is 37.5 seconds ((38+37)/2) and for JOB-B is 39.5 seconds ((39+40)/2). The source device enters the waiting state and starts waiting for the expected waiting period WPₑₓₚ(A) of 77 seconds (i.e., 39.5+37.5 seconds) for completion of powering-on action. During this occurrence, the agent detects a failure event, such as blue screen of death (BSoD), at the target device 104. The agent notifies the source device 102 to abort the request and stop waiting for a response. The source device updates the event flag 404 as “TRUE” in the experience table 400. The agent may launch a troubleshooting software (e.g., exception handler) to diagnose and analyze the cause of the failure event. After the failure event is remediated, the agent reinitiates the action and monitors the progress of the jobs (checking firmware and loading software) at the target device. For example, the agent determines the actual time taken to perform the jobs (checking firmware and loading software). The agent records that time as the actual execution time ET_{act}(j) 405 in the experience table 400. For example, the actual time 405 for JOB-A is 39 seconds and for loading software is 41 seconds.

In some examples, the source device 102 transmits a fourth request for the same action (i.e., powering on) to the target device 104. The jobs (checking firmware and loading software) performed associated with powering on are considered as fourth occurrences. The entries 457, 458 include information associated with the fourth occurrence of JOB-A and JOB-B as indicated in 403. The expected execution time ETₑₓₚ(j) 406 for the jobs JOB-A and JOB-B are considered as the average of the actual execution time ET_{act}(j) for previous occurrences of the jobs. For example, the average actual execution time ET_{act}(j) for previous execution of JOB-A is 38 seconds ((38+37+39)/3) and for JOB-B is 40 seconds ((40+39+41)/3). The source device enters the waiting state and starts waiting for the expected waiting period WPₑₓₚ(A) of 78 seconds (i.e., 40+38 seconds) for completion of the powering on. During this occurrence, the agent does not detect any event at the target device 104. The source device updates the event flag 404 as “FALSE” in the experience table 400. Further, the source device receives the response from the target device and records the actual time taken as the actual execution time ET_{act}(j). For example, the actual execution time ET_{act}(j) 405 for JOB-A may be 37 seconds and for JOB-B may be 39 seconds.

As will be understood, in some examples, the experience table 400 may also include a reduced number of columns. For example, the column 402 may be omitted. Further, in some examples, the experience table 400 may also include different types and/or an additional number of columns than depicted in FIG. 4, without limiting the scope of the present disclosure.

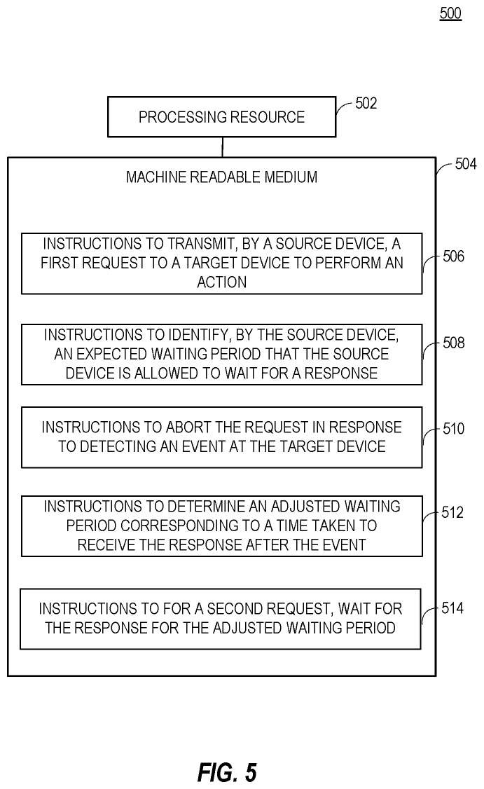

FIG. 5 is a block diagram illustrating a processing resource 502 and a machine-readable medium 504 encoded with example instructions to determine the waiting period using an agent.

The instructions 506, when executed, may cause the processing resource 502 to transmit a first request for an action from a source device to a target device. The instructions 508, when executed, may cause the processing resource 502 to identify an expected waiting period WPₑₓₚ(A) corresponding to the action. The instructions 510, when executed, may cause the processing resource 502 to abort the request in response to detecting, by an agent, an event at the target device. The instructions 512, when executed, may cause the processing resource 502 to determine an adjusted waiting period WP_{adj}(A) to complete the action at the target device due to the event. The instructions 514, when executed, may cause the processing resource 502 to wait for the response from the target device for a period corresponding to the adjusted waiting period WP_{adj}(A).

The term “source device” or “source entity,” as used herein, may refer to a computing device (e.g., a client computing device such as a laptop computing device, a desktop computing device, an all-in-one computing device, a thin client, a workstation, a tablet computing device, a mobile phone, an electronic book reader, a network-enabled appliance such as a “smart” television, smart watch, a server computing device, any virtual computing devices such as a virtual machine, container, etc., and/or other device suitable for execution of the functionality described below), a process within a computing device, and/or a state within a process. Similarly, a “target device” or “target entity,” as used herein, may refer to a computing device, a process within the computing device, and/or a state within the process. The term “process,” as used herein, may include a process task or a plurality of process tasks that are executed by a software application that runs on the computing device. A process may be in a particular “state” (as used herein) at a specific time. For example, a process may start from a waiting state and subsequently may get changed to a timeout state. While a single source device 102 and a single target device 104 are depicted in FIG. 1, the source device 102 and the target device 104 may include any number of devices. For example, the source device 102 may represent a plurality of computing devices and/or a plurality of processes/states. In some examples, the source device 102 and the target device 104 have a server-client relationship where one device represents a client computing device while the other device represents a server computing device. In other examples, the source device 102 and the target device 104 represent different processes within a single computing device.

The term “agent,” as used herein, may refer to a software application executable at a source or target device. The agent may be embedded as part of the firmware of the target device, or executable by a controller (e.g., baseboard management controller) of a server. The agent may be executable on a processor, which may be coupled with sensors, such as a microphone, temperature sensors, etc. In some examples, the agent may be capable of invoking ML services, such as voice recognition to detect audio signals (e.g., beeps) to diagnose events.

The term “action,” as used herein, may refer to a series of operations relating to command distribution, process execution, communication protocol, and/or any other actions to be processed, executed, or otherwise fulfilled by the target device. For example, an action of installing a new operating system (OS) at target device 104 relates to command distribution. A request to initiate a new FTP/HTTP session or initiate a remote management are examples of actions relating communication protocol. A request to execute certain process task (e.g., installing a new driver, invoking a new service, etc.) of a software application is an example of an action relating to process execution.

A network may include any infrastructure or combination of infrastructures that enable electronic communication between the components such as the source device 102 and the target device 104. Examples of the network may include, but are not limited to, an Internet Protocol (IP) or non-IP-based local area network (LAN), wireless LAN (WLAN), metropolitan area network (MAN), wide area network (WAN), a storage area network (SAN), a personal area network (PAN), a cellular communication network, a Public Switched Telephone Network (PSTN), and the Internet. Communication over the network may be performed in accordance with various communication protocols such as, but not limited to, Transmission Control Protocol and Internet Protocol (TCP/IP), User Datagram Protocol (UDP), IEEE 802.11, and/or cellular communication protocols over communication links 106. The communication over the network may be enabled via a wired (e.g., copper, optical communication, etc.) or wireless (e.g., Wi-Fi®, cellular communication, satellite communication, Bluetooth, etc.) communication technologies. In some examples, the network may be enabled via private communication links including, but not limited to, communication links established via Bluetooth, cellular communication, optical communication, radio frequency communication, wired (e.g., copper), and the like. In some examples, the private communication links may be direct communication links between the source device 102 and the target device 104. In some examples, the network and/or the link 106 may represent a system bus (e.g., control bus, address bus, data bus, one or more electrically conductive wires, etc. that interconnects various components of a computing device).

Although the present disclosure has been described in detail, it should be understood that various changes, substitutions, and alterations can be made without departing from the spirit and scope of the disclosure. Any use of the words “may” or “can” in respect to features of the disclosure indicates that certain examples include the feature and certain other examples do not include the feature, as is appropriate given the context. Any use of the words “or” and “and” in respect to features of the disclosure indicates that examples can contain any combination of the listed features, as is appropriate given the context.

Phrases and parentheticals beginning with “e.g.” or “i.e.” are used to provide examples merely for the purpose of clarity. It is not intended that the disclosure be limited by the examples provided in these phrases and parentheticals. The scope and understanding of this disclosure may include certain examples that are not disclosed in such phrases and parentheticals.

What is claimed is:

1. A method comprising:
transmitting, by a source device, a first request to a target device to perform an action;
identifying, by the source device, an expected waiting period that the source device is allowed to wait for a response associated with the action from the target device;
in response to detecting, by an agent deployed on the source device, an event at the target device, aborting the first request;
determining, by the agent, an adjusted waiting period based on a delay in completion of the action due to the event; and
for a second request from the source device to the target device to perform the action, waiting, by the source device, for the response from the target device for the adjusted waiting period.

2. The method of claim 1, wherein identifying the expected waiting period includes:
performing, by the source device, a lookup operation in an experience table, wherein the experience table stores at least the expected waiting period for each action; and
retrieving, by the source device, the expected waiting period corresponding to the action from the experience table.

3. The method of claim 2, further comprising:
in response to identifying the expected waiting period:
entering, by the source device, into a waiting state to wait for the response from the target device for the expected waiting period.

4. The method of claim 3, further comprising:
in response to aborting the first request:
exiting, by the source device, the waiting state to stop waiting for the response from the target device before expiry of the expected waiting period.

5. The method of claim 2, wherein retrieving the expected waiting period includes:
determining the expected waiting period based on an average of the adjusted waiting period for previous instances of the action.

6. The method of claim 2, wherein retrieving the expected waiting period includes:
in response to determining that the adjusted waiting period for previous instances of the action is not stored in the experience table based on the lookup operation:
selecting a predetermined value for the expected waiting period for the action.

7. The method of claim 1, wherein detecting the event at the target device includes:
establishing, by the agent, a remote connection to the target device;
initiating, by the agent, a reboot process at the target device; and
identifying, by the agent, the event at the target device during the reboot process.

8. The method of claim 7, wherein identifying the event at the target device during the reboot process includes:
detecting, by the agent, a user interface of the target device during the reboot process using an image recognition process; and
checking, by the agent, for a reconfiguration or a failure of one or more of a hardware component, a software component, or a firmware component of the target device.

9. The method of claim 8, further comprising:
in response to determining the failure of the one or more of the hardware component, the software component, or the firmware component of the target device:
launching an exception handler to remediate the failure.

10. A system comprising:
a machine-readable medium storing executable instructions; and
a processing resource coupled to the machine-readable medium to execute the instructions to:
transmit a first request to a target device to perform an action, wherein the first request is performed by executing one or more jobs;
identify an expected waiting period corresponding to the action based on an expected execution time for the one or more jobs associated with the action;
in response to detection of an event at the target device, abort the first request;
determine an actual execution time for the one or more jobs due to the event;
determine an adjusted waiting period corresponding to the action based on the actual execution time for the one or more jobs; and
in response to transmission of a second request to the target device to perform the action, wait for the response from the target device for the adjusted waiting period.

11. The system of claim 10, wherein to identify the expected waiting period, the processing resource executes one or more of the instructions to:
perform a lookup operation in an experience table, wherein the experience table stores the expected execution time for the one or more jobs associated with the action;
retrieve the expected execution time for the one or more jobs from the experience table; and
determine the expected waiting period corresponding to the action based on the expected execution time for the one or more jobs.

12. The system of claim 11, wherein to determine the expected waiting period, the processing resource executes one or more of the instructions to: determine the expected waiting period corresponding to the action based on a moving average of actual execution time for previous instances of the one or more jobs.

13. The system of claim 11, wherein the processing resource executes one or more of the instructions to:
in response to identifying the expected waiting period corresponding to the action:
enter a waiting state to wait for the response from the target device for the expected waiting period.

14. The system of claim 13, wherein the processing resource executes one or more of the instructions to:
in response to aborting the first request:
exit the waiting state to stop waiting for the response from the target device before expiry of the expected waiting period.

15. The system of claim 10, wherein to detect the event at the target device, the processing resource executes one or more of the instructions to:
establish a remote connection to the target device;
initiate a reboot process at the target device; and
identify the event at the target device during the reboot process.

16. The system of claim 15, wherein to identify the event at the target device during the reboot process, the processing resource executes one or more of the instructions to:
detect a user interface of the target device during the reboot process using an image recognition process; and
check for a reconfiguration or a failure of one or more of a hardware component, a software component, or a firmware component of the target device.

17. A non-transitory machine-readable medium comprising instructions executable by a processing resource, the instructions comprising instructions to:
transmit a first request from a source device to a target device to perform an action, wherein the first request is performed by executing one or more jobs;
identify an expected waiting period corresponding to the action based on an expected execution time for the one or more jobs associated with the action;
in response to a detection of an event at the target device, abort the first request;
determine an actual execution time for the one or more jobs due to the event;
determine an adjusted waiting period based on the actual execution time for the one or more jobs; and
in response to a transmission of a second request to the target device to perform the action, allow the source device to wait for the response from the target device for the adjusted waiting period.

18. The non-transitory machine-readable medium of claim 17, wherein the instructions to detect the event at the target device further comprising instructions to:
establish a remote connection to the target device;
initiate a reboot process at the target device; and
identify the event at the target device during the reboot process.

19. The non-transitory machine-readable medium of claim 17, further comprising instructions to:
in response to identifying the expected waiting period corresponding to the action:
allow the source device to enter a waiting state to wait for the response from the target device for the expected waiting period; and
in response to aborting the first request:
allow the source device to exit the waiting state to stop waiting for the response from the target device before expiry of the expected waiting period.

20. The non-transitory machine-readable medium of claim 17, wherein the event is a reconfiguration or a failure of one or more of a hardware component, a software component, or a firmware component of the target device.
